(19) United States
(12) Patent Application Publication
(10) Pub. No.: US 2015/0075335 A1
(43) Pub. Date: Mar. 19, 2015

(54) Locking pliers with extendable jaws

(71) Applicant: Bo Ren Zheng, Taichung (TW)

(72) Inventor: Bo Ren Zheng, Taichung (TW)

(21) Appl. No.: 14/551,071

(22) Filed: Nov. 23, 2014

(51) Int. Cl. B25B 7/04; B25B 7/14

(52) U.S. Cl. CPC B25B 7/04; B25B 7/14
USPC 81/387

(57) ABSTRACT

A locking pliers is provided with two pivotably joined plier arms each including a handle and a casing member having a channel; two jaw carriers each including a jaw and an arm member slidably disposed through the channel, the arm member including external teeth on top and bottom respectively; a biasing member put on the pivot joint and including two arm elements each having a hook end fictionally put on the top teeth of the arm member; and two rollers each including teeth and rotatably disposed on a bottom of the channel, the teeth of the roller being in rotatable tooth engagement with the bottom teeth of the arm member. The bottom teeth of the arm member are lockingly engaged with the teeth of the roller when a force is exerted on an exposed portion of the arm member.

### BACKGROUND OF THE INVENTION

1. Field of the Invention

The invention relates to locking pliers and more particularly to a pair of locking pliers having two arms at one ends of two handles respectively, the arms being adapted to extend to draw two jaws away from each other or retract to draw the jaws toward each other.

2. Description of Related Art

A conventional locking pliers 1 is shown in FIG. 14 and comprises two handles 2 pivotably secured by a pivot 3, a link and quick release assembly 8 having both ends pivotably secured to the handles 2 respectively; a hole 4 in a distal portion of each handle 2, two arms 7 each having one end moveably disposed in the hole 4, two jaws 5 each having one end secured to the other end of the arm 7 and the other end adapted to clamp an object by cooperating with the other jaw 5, and two clamping members 6 each disposed on an inner surface of the hole 4 for frictionally fastening the arm 7.

However, the conventional pair of locking pliers is not reliable in operation due to structural deficiencies. Further, it tends to malfunction. Thus, the need for improvement still exists.

### SUMMARY OF THE INVENTION

It is therefore one object of the invention to provide a locking pliers comprising a first plier arm including a first handle and a first casing member having a first channel; a second plier arm including a second handle and a second casing member having a second channel; a pivot joint for pivotably joining the first and second handles; a first jaw carrier including a jaw at an open end, and a first arm member slidably disposed through the first channel and having a first end secured to the first jaw carrier, the first arm member including external teeth on a top surface and a bottom surface respectively, and a projection at a second end; a second jaw carrier including a jaw at an open end, and a second arm member slidably disposed through the second channel and having a first end secured to the second jaw carrier, the second arm member including external teeth on a top surface and a bottom surface respectively, and a projection at a second end; a biasing member put on the pivot joint and including a first arm element having a hook end fictionally put on the teeth on the top surface of the first arm member, and a second arm element having a hook end frictionally put on the teeth on the top surface of the second arm member; a first roller including teeth formed on an outer surface, the first roller being rotatably disposed on a bottom of the first channel and the teeth of the first roller being in rotatable tooth engagement with the teeth on the bottom surface of the first arm member; and a second roller including teeth formed on an outer surface, the second roller being rotatably disposed on a bottom of the second channel and the teeth of the second roller being in rotatable tooth engagement with the teeth on the bottom surface of the second arm member; wherein the first arm member is configured to pull out of the first channel a first predetermined distance; wherein the second arm member is configured to pull out of the second channel a second predetermined distance; wherein the teeth on the bottom surface of the first arm member are lockingly engaged with the teeth of the first roller when a first force is exerted on an exposed portion of the first arm member; and wherein the teeth on the bottom surface of the second arm member are lockingly engaged with the teeth of the second roller when a second force is exerted on an exposed portion of the second arm member.

The above and other objects, features and advantages of the invention will become apparent from the following detailed description taken with the accompanying drawings.

### BRIEF DESCRIPTION OF THE DRAWINGS

FIG. 1 is a perspective view of a pair of locking pliers according to a first preferred embodiment of the invention;

FIG. 2 is a side elevation is part section of the locking pliers;

FIG. 3 is a view similar to FIG. 2 showing the jaws being disengaged in a ready to clamp position;

FIG. 4 is a sectional view taken along line 4-4 of FIG. 3;

FIG. 5 is a fragmentary in part section view of the jaw assembly, the arm, and components adjacent the arm showing the arm being fully extended;

FIG. 6 is an enlarged view of the right side portion of FIG. 5 showing teeth engagement of the arm with toothed surface of the roller when the arm is not free to extend or retract in response to force exerting thereon;

FIG. 7 is a perspective view of the roller;

FIG. 8 is an enlarged view of the left top portion of FIG. 6 showing teeth engagement of the arm with toothed surface of the roller when the arm is free to extend or retract in response to no force exerting thereon;

FIG. 9 is a view similar to FIG. 8 showing teeth engagement of the arm with toothed surface of the roller when the arm is not free to extend or retract in response to force exerting thereon;

FIG. 9A is a view similar to FIG. 9 showing another configuration of the roller where the roller is disposed at an opposite side;

FIG. 10 is a perspective view of a pair of locking pliers according to a second preferred embodiment of the invention;

FIG. 11 is a fragmentary in part section of the locking pliers of FIG. 10 showing the arm and adjacent components;

FIG. 12 is an enlarged view of the left top portion of FIG. 11 showing teeth engagement of the arm with toothed surface of each roller when the arm is not free to extend or retract in response to force exerting thereon;

FIG. 13 is a view similar to FIG. 12 showing another configuration of the roller where the roller has top teeth a which are in tooth engagement with the bottom teeth of the arm; and

FIG. 14 is a side elevation in part section of a conventional pair of locking pliers, the lock pliers being open with a piece being clamped by the jaws.

### DETAILED DESCRIPTION OF THE INVENTION

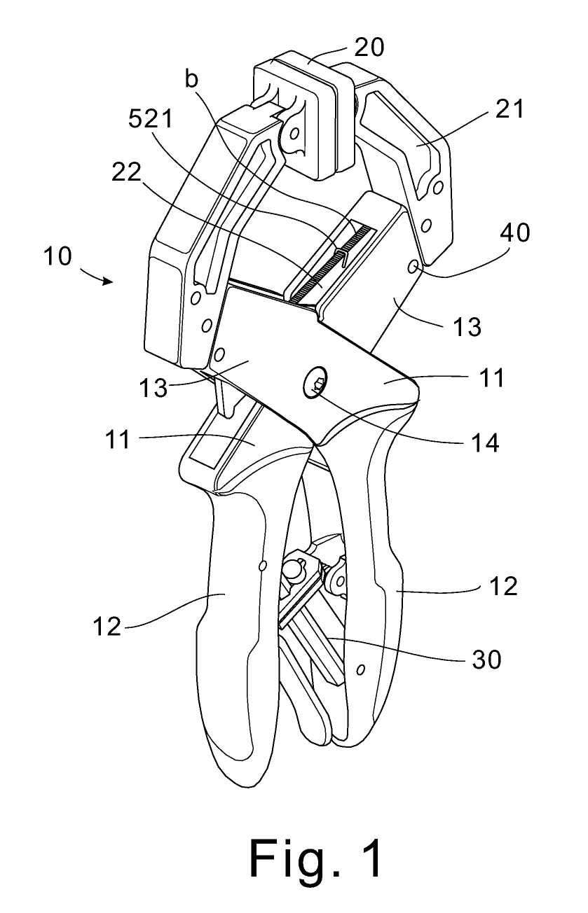

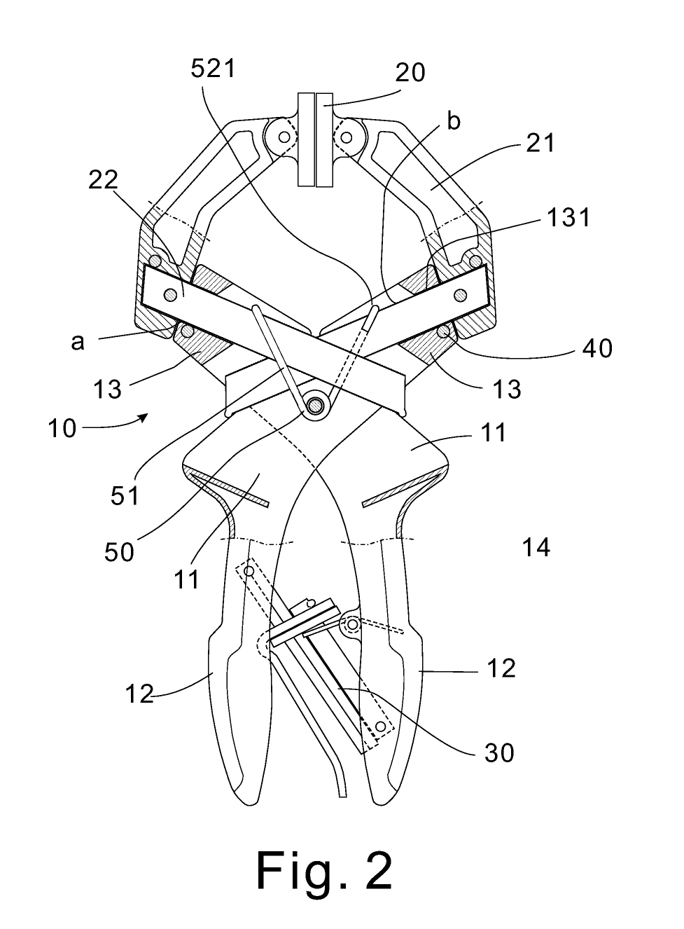

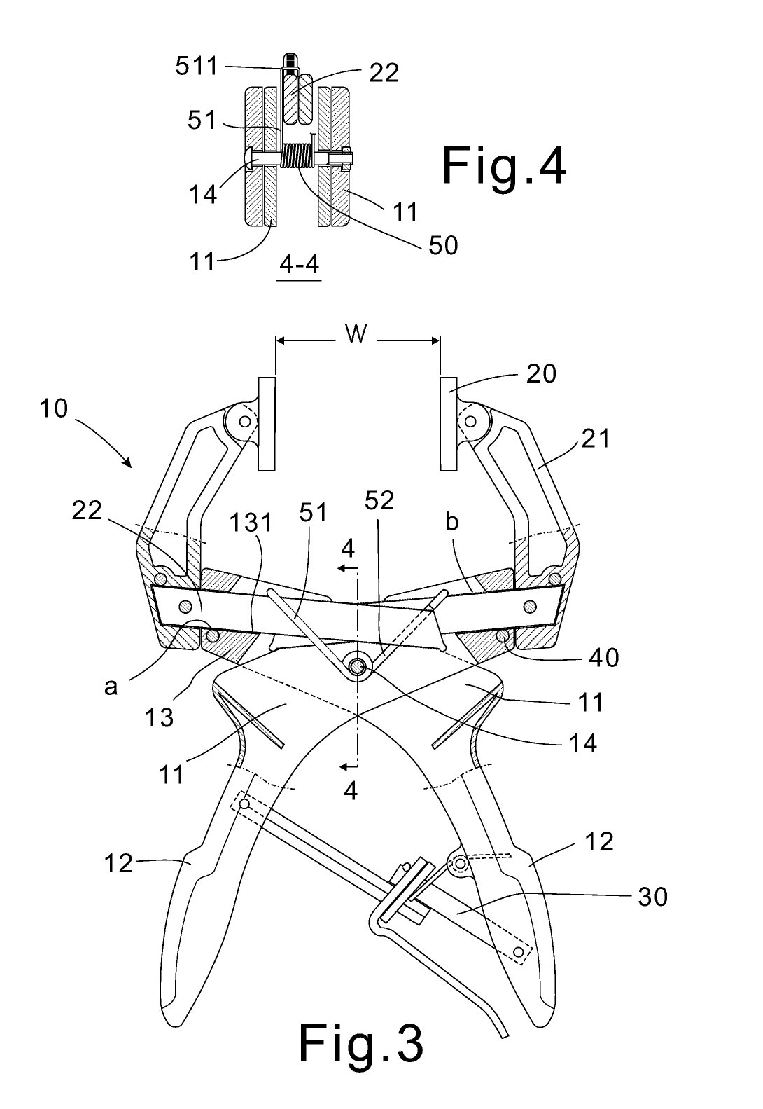

Referring to FIGS. 1 to 9, a pair of locking pliers 10 in accordance with a first preferred embodiment of the invention comprises the following components as discussed in detail below.

Two bent plier arms 11 each include a handle 12 and an inclined casing member 13. The housings 13 are pivotably joined at a pivot joint 14. A link and quick release assembly 30 has both ends pivotably secured to the handles 12 respectively. A channel 131 is formed through the casing member 13. Two jaw carriers 21 each comprises a pivotal jaw 20 at an open end, and an arm 22 slidably disposed through the channel 131 and having one end secured to the jaw carrier 21. The arm 22 includes external teeth b on a top surface 222 and a bottom surface 221 respectively, and a projection 223 at the other end. The projection 223 is used to prevent the arm 22 from being inadvertently pulled out of the channel 13. A torsion spring 50 is put on the pivot joint 14 and includes a first arm 51 having a hook end 511 fictionally put on the teeth b on the top surface 222 of one arm 22, and a second arm 52 having a hook end 521 frictionally put on the teeth b on the top surface 222 of the other arm 22. Two rollers 40 each include an outer surface 401 formed with teeth a. The roller 40 is rotatably provided on a bottom of the channel 131 at an open end of the casing member 13 facing the jaw carrier 21. The teeth a of the roller 40 are in rotatable tooth engagement with the teeth b on the bottom surface 221 of the arm 22.

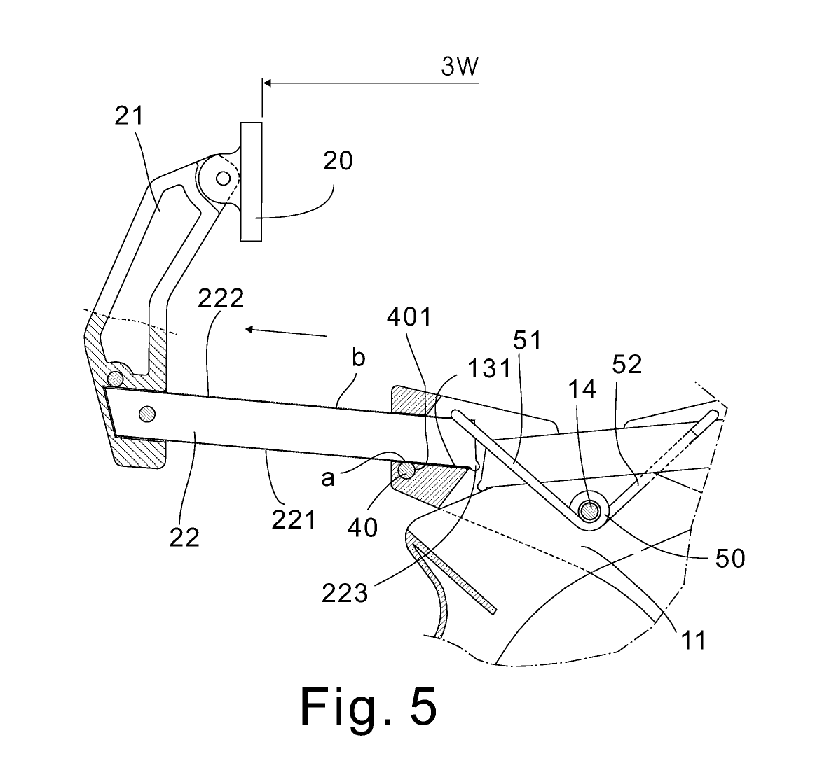

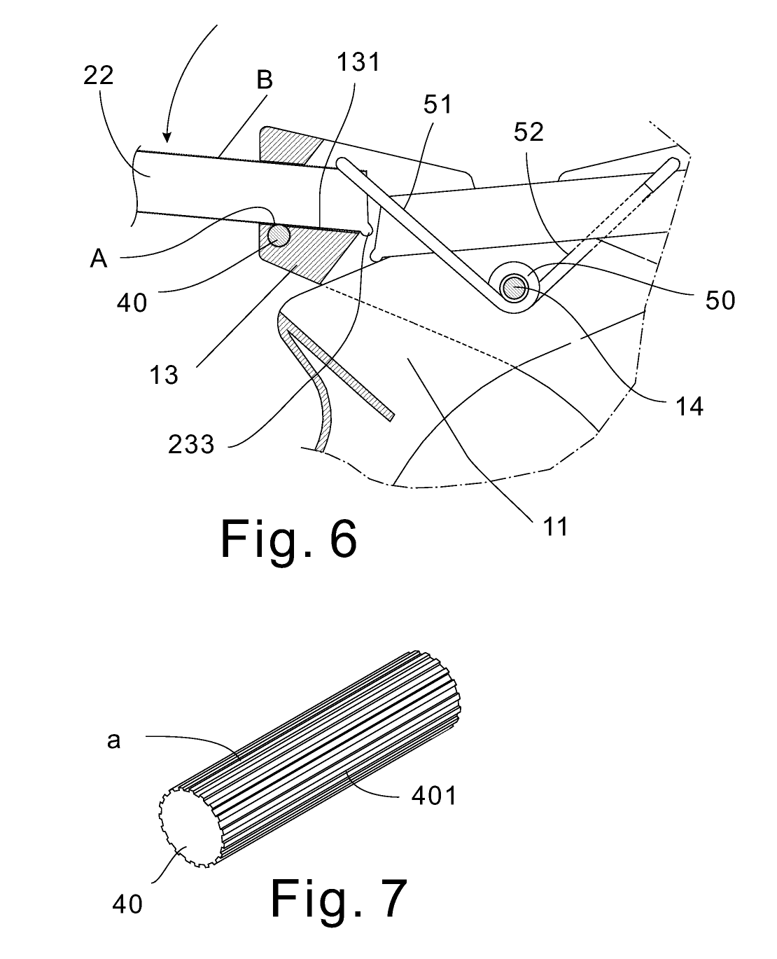

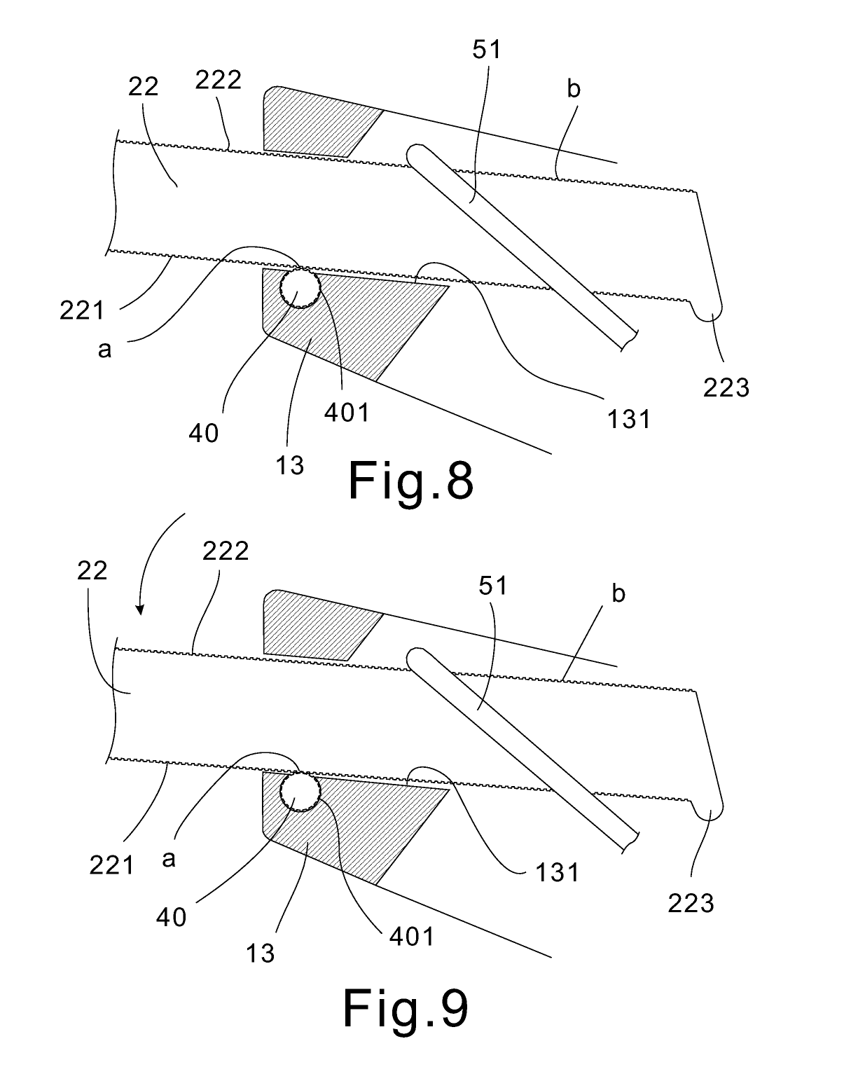

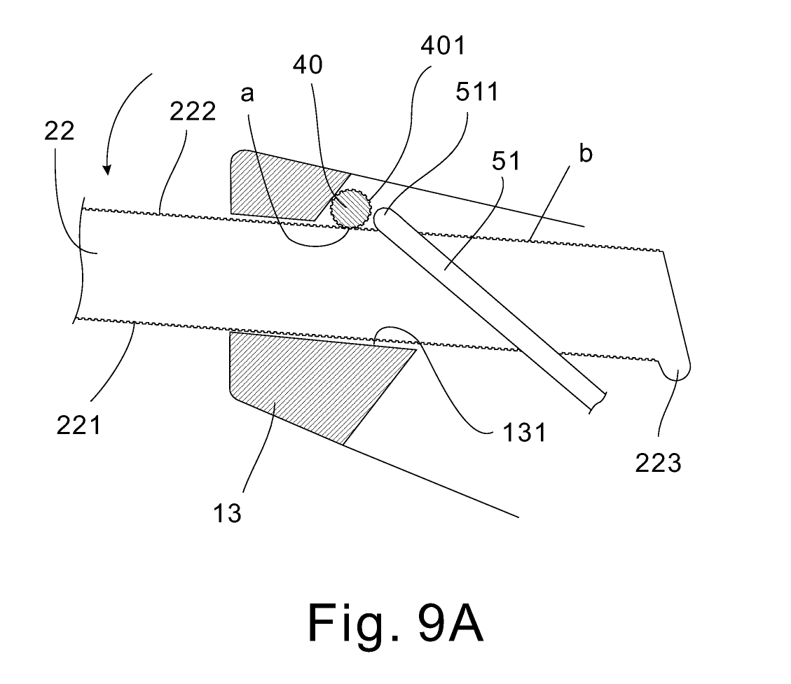

In use including distance adjustment, a user may pull the arm(s) 22 a desired distance so that a distance such as W or 3W can be obtained. Further, a piece (not shown) can be clamped by the jaws 20. The characteristics of the invention are that the pulling of the arm 22 is not obstructed (see FIGS. 5 and 8). But the teeth b on the bottom surface 221 of the arm 22 are lockingly engaged with the teeth a of the roller 40 when a force is exerted on an exposed portion of the arm 22 (see FIGS. 6 and 9). This is the case when the piece is clamped by the jaws 20. Thus, the clamped piece is secured without being loosened.

Referring to FIG. 9A, in another configuration each of the rollers 40 are rotatably provided between an inner end of the channel 131 and the hook end 511 of the torsion spring 50 and the teeth a of the roller 40 are in rotatable tooth engagement with the teeth b on the top surface 222 of the arm 22.

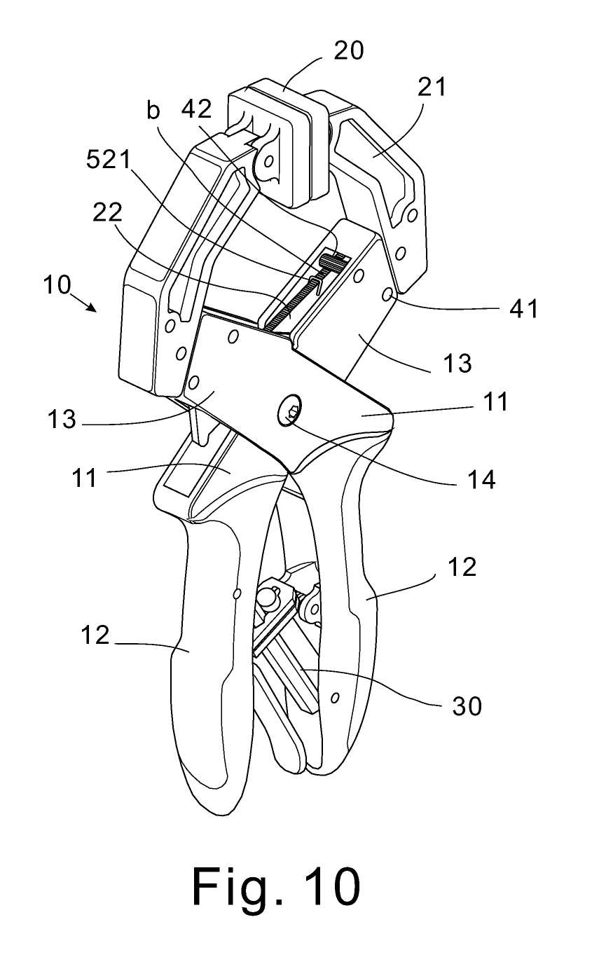

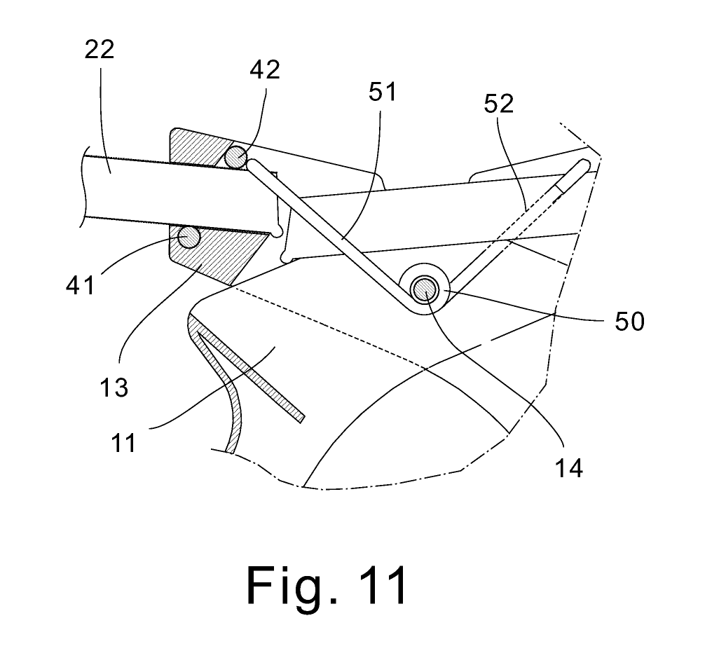

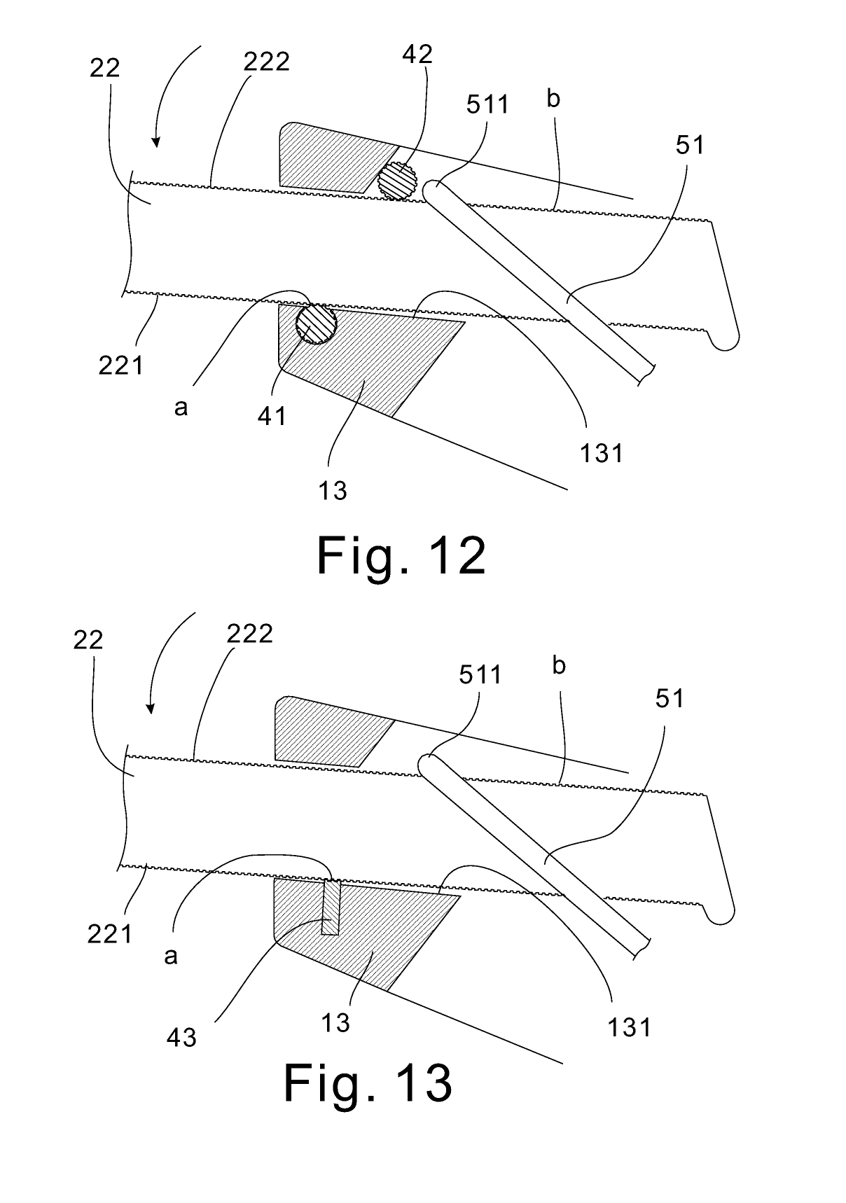

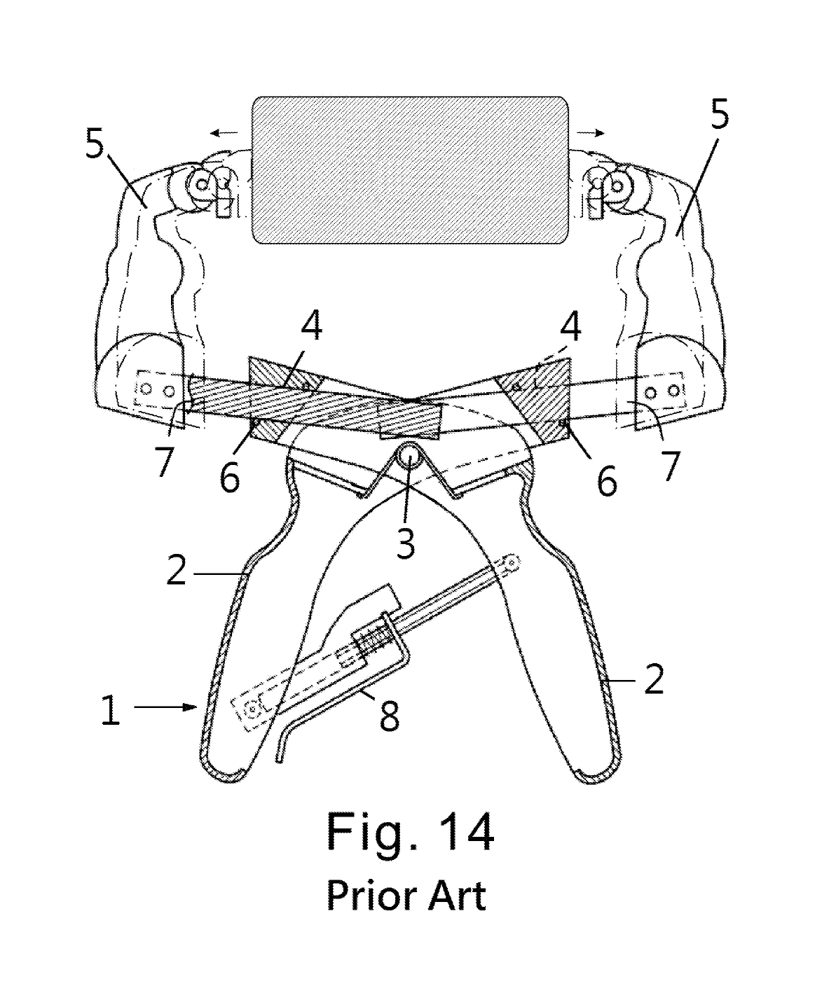

Referring to FIGS. 10 and 12, a pair of locking pliers 10 in accordance with a second preferred embodiment of the invention is shown. The characteristics of the second preferred embodiment are substantially the same as that of the first preferred embodiment except the following:

The roller is replaced with a first roller 41 and a second roller 42. The first roller 41 is rotatably provided on a bottom of the channel 131 at an open end of the casing member 13 facing the jaw carrier 21. The teeth a of the first roller 40 are in rotatable tooth engagement with the teeth b on the bottom surface 221 of the arm 22. The second roller 42 is rotatably provided between an inner end of the channel 131 and the hook end 511 of the torsion spring 50 and the teeth a of the roller 40 are in rotatable tooth engagement with the teeth b on the top surface 222 of the arm 22.

Referring to FIG. 13, in another configuration a plate member 43 is rotatably provided on a bottom of the channel 131 at an open end of the casing member 13. Top teeth a of the plate 43 are in rotatable tooth engagement with the teeth b on the bottom surface 221 of the arm 22.

While the invention has been described in terms of preferred embodiments, those skilled in the art will recognize that the invention can be practiced with modifications within the spirit and scope of the appended claims.

What is claimed is:

1. A locking pliers comprising:
a first plier arm including a first handle and a first casing member having a first channel;
a second plier arm including a second handle and a second casing member having a second channel;
a pivot joint pivotably joined the first and second handles;
a first jaw carrier including a jaw at an open end, and a first arm member slidably disposed through the first channel and having a first end secured to the first jaw carrier, the first arm member including external teeth on a top surface and a bottom surface respectively, and a projection at a second end;
a second jaw carrier including a jaw at an open end, and a second arm member slidably disposed through the second channel and having a first end secured to the second jaw carrier, the second arm member including external teeth on a top surface and a bottom surface respectively, and a projection at a second end;
a biasing member put on the pivot joint and including a first arm element having a hook end fictionally put on the teeth on the top surface of the first arm member, and a second arm element having a hook end frictionally put on the teeth on the top surface of the second arm member;
a first roller including teeth formed on an outer surface, the first roller being rotatably disposed on a bottom of the first channel and the teeth of the first roller being in rotatable tooth engagement with the teeth on the bottom surface of the first arm member; and
a second roller including teeth formed on an outer surface, the second roller being rotatably disposed on a bottom of the second channel and the teeth of the second roller being in rotatable tooth engagement with the teeth on the bottom surface of the second arm member;
wherein the first arm member is configured to pull out of the first channel a first predetermined distance;
wherein the second arm member is configured to pull out of the second channel a second predetermined distance;
wherein the teeth on the bottom surface of the first arm member are lockingly engaged with the teeth of the first roller when a first force is exerted on an exposed portion of the first arm member; and
wherein the teeth on the bottom surface of the second arm member are lockingly engaged with the teeth of the second roller when a second force is exerted on an exposed portion of the second arm member.

2. The locking pliers of claim 1, further comprising a third roller rotatably disposed between an inner end of the first channel and the hook end of the first arm element of the biasing member, the third roller including teeth being in rotatable tooth engagement with the teeth on the top surface of the first arm member; and a fourth roller rotatably disposed between an inner end of the second channel and the hook end of the second arm element of the biasing member, the fourth roller including teeth being in rotatable tooth engagement with the teeth on the top surface of the second arm member.
